(19) United States
(12) Patent Application Publication
(10) Pub. No.: US 2010/0138643 A1
(43) Pub. Date: Jun. 3, 2010

(54) Media controller

(75) Inventor: Jin Yi Huang, Tainan Hsien (TW)

Correspondence Address: BACON & THOMAS, PLLC, 625 SLATERS LANE, FOURTH FLOOR, ALEXANDRIA, VA, 22314-1176, US

(73) Assignee: Ya Horng Electronic Co., Ltd., Tainan Hsien (TW)

(21) Appl. No.: 12/585,322

(22) Filed: Sep. 11, 2009

(30) Foreign Application Priority Data
Dec. 2, 2008 (TW) 097221593

(51) Int. Cl. G06F 15/177

(52) U.S. Cl. 713/2

(57) ABSTRACT

A media controller is disclosed, which is a memory storing device, made up of an operating system and a piece of multimedia software, where the operating system is made merely for the multimedia software and available for the booting. And the multimedia software is an application program running on the operating system and is able to fetch the songs stored in the computer for overdubbing and sound effects processing. The selection of the memory storing device is the first priority to read during the booting. Once the new setting is saved, the computer is then ready to reboot. The memory storing device then takes charge of the execution of the operating system in the memory storing device. A user is then ready to run the multimedia software on the operating system, and further to operate the input device to fetch the songs stored in the computer for overdubbing and sound effects processing, to greatly achieve the stable playing of sound effects by making use of the existing computer equipment.

### BACKGROUND OF THE INVENTION

1. Field of the Invention

This invention relates generally to a media controller and more particularly to the media controller that is connected with a computer, where a user can make use of an operating system stored in the memory storing device of the media controller for the booting, and the operating system, made merely for the multimedia software running thereon, takes charge of the overall operating environment, which substantially boosts the efficacy of the computer to the user for executing multimedia applications.

2. Description of the Prior Art

There are quite many ways to process the songs for overdubbing sound effects by DJs in the Pubs. Some scrape a hand on the black rubber record on the turntable to make grinding sound. And others store music in the memory of computer. By the coordination with DJ-applied multimedia software in the computer, the DJs can manipulate an input device to achieve the manipulation of the songs stored in the computer for overdubbing and sound effects. However, under multiple operating system environments, the software processing can be retarded, and the operation of the computer can also be unstable. Meanwhile, the play of the sound effects will suffer the retard simultaneously.

### SUMMARY OF THE INVENTION

In the light of the aforesaid drawbacks, the present inventor conceived the idea of the improvement after a longtime endeavor, and eventually the endeavor gave birth to this invention.

The objective of this invention is to provide a media controller that is capable of making use of existing computer equipment to achieve a stable playing of sound effects.

To achieve the aforementioned purpose, the media controller of this invention is a memory storing device, made up of an operating system and a piece of multimedia software, where the operating system is made merely for the multimedia software and available for the booting, and the multimedia software is an application program running on the operating system and is able to fetch the songs stored in the computer for overdubbing and sound effects processing. The media controller is controlled by an input device, which enables the computer to output the sound effects. In the use of this invention, a user turns on the computer to enter basic input output system (BIOS) for the alteration of booting sequence, followed by the selection of the memory storing device to be the first priority to read during the booting. Once the new setting is saved, the computer is then ready to reboot. The memory storing device now takes charge of the booting and the execution of the operating system in the memory storing device. A user is then ready to run the multimedia software on the operating system. And the user can further operate the input device to fetch the songs stored in the computer for overdubbing and sound effects processing, to achieve the stable playing of sound effects by making use of the existing computer equipment.

### BRIEF DESCRIPTION OF THE DRAWING

FIG. 1 is a block diagram of the system of the embodiment of this invention.

### DETAILED DESCRIPTION OF THE INVENTION

To achieve the aforesaid objects of this invention, the technique adopted and the function achieved are detailed described with reference to the following preferred embodiments and the accompanying drawings

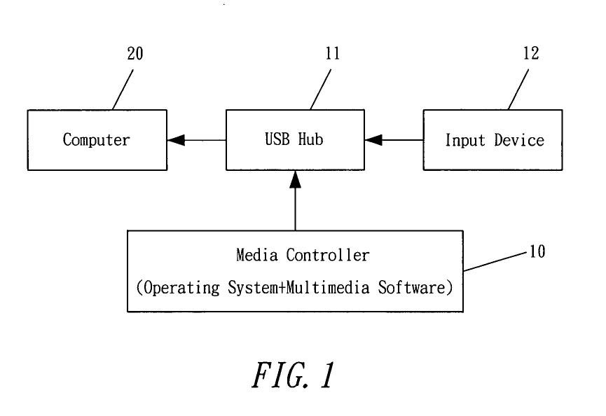

Referring to FIG. 1, the media controller 10 of this invention is a memory storing device, where its output end is connected with a universal serial bus (USB) hub 11 (can be a built-in USB slot of a computer 20), and comprises an operating system (for instance: Linux) and a piece of multimedia software (for instance: DJ software), where the operating system is available for booting. And the multimedia software is an application program running on the operating system, which is also able to fetch the songs stored in the computer 20 for overdubbing and sound effects processing. The media controller 10 is controlled by an input device 12 (a human-machine interface), which is connected with the USB hub 11 through the output end of input device 12, to control the multimedia software of the media controller 10. The input device may have the input adjusting gadgets: button, knob, fader, and wheel.

At the moment to use this invention, a user turns on the computer 20 to enter basic input output system (BIOS) for the alteration of booting sequence, followed by the selection of the memory storing device in the media controller 10 to be the first priority to read during the booting. Once the new setting is saved, the computer 20 is then ready to reboot. The memory storing device of the media controller 10 now takes charge of the system booting and the execution of the operating system (for instance: Linux) in the memory storing device. A user is then ready to run the multimedia software (for instance: DJ software) on the operating system. And the user can further operate the input device 12 to fetch the songs stored in the computer 20 for overdubbing and sound effects processing.

By means of the selection of the memory storing device of the media controller 10 as the first priority during the booting for the computer 20 of this invention, the computer 20 reads first the memory storing device after system power-on. And the computer 20 proceeds to execute the operating system (for instance: Linux) in the memory storing device that is made merely for the multimedia software, followed by the execution of the multimedia software (for instance: DJ software) in the memory storing device. By manipulating the input device 12, the user is available to fetch the songs stored in the computer 20 for overdubbing and sound effects processing. A special operating environment is made for the multimedia software through this invention, to achieve the outcome of stabilizing the output of the sound effects.

The media controller 10 is also available to be built in the input device 12, which is to accommodate a storing device in the input device 12, where the storing device contains an operating system (for instance: Linux) for the media controller 10 and a piece of multimedia software (for instance: DJ software), and the media controller 10 is connected with the input device 12, which together joins the computer 20 by a common USB transmitting line.

In conclusion, the present invention is construed to be creative and useful aside from novel, which is compliant to the utility patent requirements; an application is now filing for utility patent according to the law, which deserves your favorable examination and approval.

What is claimed is:

1. A media controller, featuring:
the media controller being a memory storing device, made up of an operating system and a piece of multimedia software, where the operating system is made merely for the multimedia software and available for booting, and the multimedia software being an application program running on the operating system and being able to fetch the songs stored in the computer for overdubbing and sound effects processing; the media controller being controlled by an input device, which enables the computer to output the sound effects.

2. A media controller as in claim 1 wherein the input device may include input adjusting gadgets: button, knob, fader, and wheel.

3. A media controller as in claim 1 wherein the operating system may be a Linux operating system.

4. A media controller as in claim 1 wherein the multimedia software may be a piece of software for the use by the DJ.

5. A media controller as in claim 1 wherein the media controller is available for being built inside the input device, which is to accommodate a storing device in the input device, where the storing device is provided with the operating system for the media controller and the multimedia software, and the media controller being connected with the input device which together joins the computer by a common transmitting line.
